(19) United States
(12) Patent Application Publication
(10) Pub. No.: US 2009/0322538 A1
(43) Pub. Date: Dec. 31, 2009

(54) TAMPER EVIDENT SECURITY FILM

(75) Inventors: Robin Kobren, Riegelsville, PA (US); Gerard Shanley, Ringoes, NJ (US)

Correspondence Address: FOX ROTHSCHILD LLP, 2000 MARKET STREET, 10th Floor, PHILADELPHIA, PA, 19103, US

(73) Assignee: Dunmore Corporation, Bristol, PA (US)

(21) Appl. No.: 11/733,890

(22) Filed: Apr. 11, 2007

Related U.S. Application Data
(60) Provisional application No. 60/793,585, filed on Apr. 20, 2006.

(51) Int. Cl. G08B 13/14; B05D 1/36; B05D 5/10; B32B 3/02; B32B 3/10

(52) U.S. Cl. 340/572.8; 427/258; 427/207.1; 428/202

(57) ABSTRACT

A security film adapted to display a message indicative of tampering is disclosed. A light transmitting sheet has a first layer on one surface, a release layer on a portion of the opposite surface, and a second layer covering the release layer and another portion of the opposite surface. The first layer is a metal and the second layer is a metal or a non-metal. An adhesive layer on the second surface adheres the film to a substrate. Removal of the sheet from the substrate causes the sheet to separate from the second layer under the release layer making a release layer pattern visible on both the sheet and substrate as reverse images. A method disclosed includes metalizing a light transmitting sheet with a metal layer on one side and a release layer and a metal or a non-metal layer on the opposite side.

### CROSS REFERENCE TO RELATED APPLICATION

This application is based on and claims priority to U.S. Provisional Application No. 60/793,585, filed Apr. 20, 2006.

### FIELD OF THE INVENTION

This invention relates to a multi-layer tamper evident film adherable to a substrate, the film displaying permanent, visible evidence when it is removed from the substrate.

### BACKGROUND OF THE INVENTION

Tamper evident security film is used to provide security against tampering, theft and counterfeiting. The film may be in the form of an adhesive tape applied to seal packaging and provide visible evidence that a package was opened, thereby providing an indication of potential tampering with the package contents. The film may be in the form of a decal or sticker, such as those affixed to automobile license plates, that are displayed to indicate compliance with registration requirements. Upon removal of the decal, an otherwise hidden message may be revealed on the decal that indicates unauthorized removal thereby voiding the decal, or the indicia displayed on the decal may be disrupted to render them unreadable and thereby deter theft. The film may also be in the form of a label applied to a product which reveals an otherwise hidden code when removed, absence of the label or the proper code being an indication of counterfeited goods. These products could also be used to hide user information on gaming cards, lottery cards and prepaid telephone cards with or without scratch-off inks that would indicate tampering.

Films having tamper evident characteristics according to the prior art may comprise a transparent face stock made of a polymer such as polyethyleneterepthalate on which a release layer, such as polyvinyl alcohol, is printed in the form of a pattern or indicia. A primer layer, for example, a polyester varnish, is applied over the release layer and the face stock. A frangible metal layer, such as vapor deposited aluminum, covers the primer layer. An adhesive layer covers the metal layer and is used to apply the film to a substrate. The total thickness of the film is between 2 and 3 mils.

The weakest adherence between the various layers exists between the face stock and the release layer. If the face stock is removed from the substrate, the face stock separates from the release layers, leaving the primer and metal layers behind still adhered to the substrate by the adhesive layer. In regions where there is no release layer, the primer layer, the metal layer and the adhesive layer pull away from the substrate and remain with the face stock.

The release layer is printed in the form of a pattern or indicia. When the layers are intact (i.e., before removal from the substrate), the pattern or indicia are invisible. When the layers are disrupted by removal of the face stock from the substrate, the pattern becomes visible on the substrate as a positive image and on the face stock as a negative image.

One disadvantage of films according to the prior art is the complexity of the different layers. For example, for the hidden pattern or indicia to be invisible, it is necessary to match the index of refraction of the release layer closely with that of the primer layer. This is often difficult to achieve and maintain throughout a large production run, resulting in significant product wastage and added expense.

### SUMMARY OF THE INVENTION

The invention concerns a security film attachable to a substrate and adapted to display evidence of removal therefrom. The security film comprises a light transmitting sheet having a first and a second surface oppositely disposed. A first layer is attached to the first surface. A release layer is attached to but a portion of the second surface. A second layer overlies the second surface, the second layer including a first portion attached to the release layer and a second portion attached to at least a portion of the second surface not covered by the release layer. The second layer is attachable to the substrate. The first layer has a higher light transmissibility than the second layer. The release layer has a greater adherence to the second layer than to the light transmitting sheet such that upon removal of the light transmitting sheet from the substrate, the first portion of the second layer remains attached to the substrate, and the second portion of the second layer remains attached to the light transmitting sheet.

In a particular embodiment, the security film according to the invention comprises a light transmitting sheet having a first and a second surface oppositely disposed. A first metal layer is attached to the first surface. A transparent release layer is attached to but a portion of the second surface. A second metal layer overlies the second surface. The second metal layer includes a first portion attached to the release layer and a second portion attached to at least a portion of the second surface not covered by the release layer. The second metal layer is attachable to the substrate. The first metal layer has a higher light transmissibility than the second metal layer. The release layer has a greater adherence to the second metal layer than to the light transmitting sheet such that upon removal of the light transmitting sheet from the substrate, the first portion of the second metal layer remains attached to the substrate, and the second portion of the second metal layer remains attached to the light transmitting sheet.

In an alternate embodiment, the second layer is a non-metal layer, for example, a pigmented layer.

In another embodiment, the security film comprises a light transmitting sheet having a first and a second surface oppositely disposed. A first layer is attached to the first surface. A release layer is attached to but a portion of the second surface. The first layer has a higher light transmissibility than the release layer such that, when viewed through the first layer, the release layer is not visible. A second layer overlies the second surface. The second layer includes a first portion attached to the release layer and a second portion attached to at least a portion of the second surface not covered by the release layer. The second layer is attachable to the substrate. The release layer has a greater adherence to the second layer than to the light transmitting sheet such that upon removal of the light transmitting sheet from the substrate, the release layer remains attached to the substrate. The release layer may be tinted, and the second layer may comprise an adhesive.

The invention also encompasses a method of making a security film attachable to a substrate and adapted to display evidence of removal of the security film from the substrate. The method comprises:

(a) providing a light transmitting sheet having a first and a second surface oppositely disposed;

(b) metalizing the first surface with a metal layer having a first light transmissibility;

(c) coating but a portion of the second surface with a release layer; and

(d) applying to the second surface and the release layer a second layer having a second light transmissibility, the first light transmissibility being higher than the second light transmissibility.

The method may further include coating the second layer with an adhesive layer for attaching the security film to the substrate.

Another method for making a security film comprises:

(a) providing a light transmitting sheet having a first and a second surface oppositely disposed;

(b) metalizing the first surface with a metal layer;

(c) coating but a portion of the second surface with a release layer, the first metal layer having a higher light transmissibility than the release layer such that, when viewed through the first metal layer, the release layer is not visible; and

(d) applying to the second surface and the release layer a second layer, the second layer being attachable to the substrate, the release layer having a greater adherence to the second layer than to the light transmitting sheet such that upon removal of the light transmitting sheet from the substrate, the release layer remains attached to the substrate.

### BRIEF DESCRIPTION OF THE DRAWINGS

FIG. 1 is a cross-sectional view of a security film according to the invention shown on an enlarged scale;

FIG. 1A is a cross-sectional view of an alternate embodiment of a security film according to the invention shown on an enlarged scale;

FIG. 2 is a cross-sectional view of the security film shown in FIG. 1 being disrupted by removal from a substrate;

FIG. 3 is a perspective view of a security film being removed from a substrate and displaying visible evidence of removal of the film in the form of indicia;

FIG. 4 is a perspective view of a security film being removed from a substrate and displaying evidence of removal visible under ultraviolet or infrared light;

FIG. 5 is a perspective view of a security film being removed from a substrate and displaying a radio frequency antenna;

FIG. 5A is a cross-sectional view of a security film in which a radio frequency antenna is embedded;

FIG. 6 is a perspective view of a security film being removed from a substrate and displaying visible evidence of removal in the form of a pattern to include tagents;

FIG. 7 is a cross-sectional view of another embodiment of a security film according to the invention shown on an enlarged scale; and

FIG. 8 is a cross-sectional view of the security film shown in FIG. 7 being disrupted by removal from a substrate.

### DETAILED DESCRIPTION OF THE EMBODIMENTS

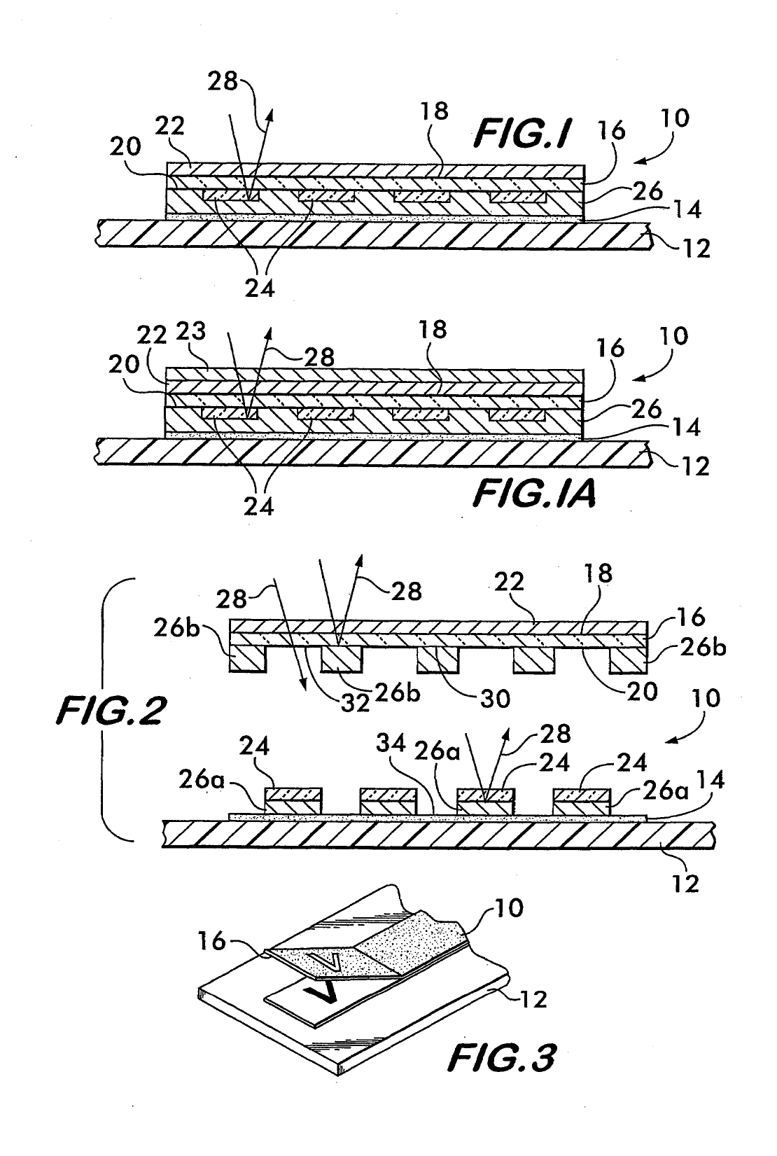

FIG. 1 shows a cross-sectional view of a security film 10 according to the invention. The security film is applied to a substrate 12 using an adhesive layer 14. The security film 10 comprises a light transmitting sheet 16 having oppositely disposed surfaces 18 and 20. Surface 18 faces outwardly away from substrate 12. An outer layer 22 is attached to this surface and forms the layer through which the security characteristics of the film will be viewed. The outer layer 22 comprises a metal layer.

A transparent release layer 24 is attached to the opposite surface 20 which faces the substrate 12. Release layer 24 is applied in a pattern or in the form of indicia, such as a trademark, and may be continuous or non-continuous over the surface 20. The pattern of the release layer contains the intelligence or “message” that is conveyed when the security film is disrupted by attempted removal from the substrate as described in detail below.

An inner layer 26 is attached to the release layer 24 and to at least a portion of the substrate-facing surface 20 of the light transmitting sheet 16 that is not covered by the release layer 24. The inner layer 26 may comprise a metal layer or a non-metal layer. The release layer 24 has greater adhesion to the inner layer 26 than to the light transmitting sheet 16 to permit separation of the release layer from the sheet as described below. The adhesive layer 14 is applied between the inner layer 26 and the substrate 12 to adhere the film 10 thereto. The adhesive layer may be included as a part of the film 10, or it may be applied to the film or the substrate separately to effect attachment of the film to the substrate.

In one embodiment, the outer and inner layers 22 and 26, are preferably formed of the same metal, although different metals having similar optical properties with respect to light reflection (i.e., metals that are similar in color) may also be feasible. For example, it may be possible to have the outer metal layer be aluminum and the inner metal layer be silver. When the layer 26 is a non-metal layer, for example, a pigmented or opaque color layer, then it is preferable that the pigments or colors of the inner and outer layers also have similar optical properties (i.e., similar in color).

The light transmissibility of the inner and outer layers, which is a measure of the amount of incident light that is transmitted through these layers, is controlled as described below to render the release layer 24 invisible when the film 10 is intact, and visible when the layers are disrupted. To that end, the light transmissibility of the outer layer 22 is greater than the light transmissibility of the inner layer 26 such that the outer layer transmits a significant portion of incident light and the inner layer reflects a significant portion of incident light. When the film 10 is intact and attached to a substrate 12 as shown in FIG. 1, incident light 28 is transmitted through the outer layer 22, through the light transmitting sheet 16 and the transparent release layer 24 to the inner layer 26 where it is reflected back through the layers of the film. (When the layer 26 is an opaque pigment, a portion of the incident light is absorbed.) In this condition, with the various layers intact, the pattern or indicia formed by the release layer 24 is not visible by the light 28 reflected from the inner layer 26. The inner and outer layers 22 and 26 work together to camouflage the pattern or indicia formed by the release layer 24.

However, when the layers of film 10 are disrupted by attempted removal of the film from the substrate 12 as shown in FIG. 2, the light transmitting sheet 16 separates from the release layer 24 due to the lower adhesion of the release layer to the light transmitting sheet as compared with the release layer's adhesion to the inner layer 26. Where release layer is present, the inner layer 26a beneath the release layer 24 remains attached to the substrate 12, as shown in the lower half of FIG. 2. Where there is no release layer, however, the inner layer 26b remains attached to the light transmitting sheet 16 as shown in the upper half of FIG. 2. This disruption of the layers renders the pattern or indicia formed by the release layer visible as a positive image on the substrate 12, and as a complementary negative image on the light transmitting sheet 16.

As shown in FIG. 2 for the disrupted layers, incident light 28 passes through the outer layer 22 and the light transmitting sheet 16. Where the inner layer 26b still adheres to portions 30 of the sheet 16, light 28 is reflected. Light is not reflected from sheet portions 32 where release layer 24 was attached to the sheet. This absence of reflected light results in the pattern defined by the release layer being visible as a “hole” or negative image on the light transmitting sheet 16. Similarly, light 28 incident on the substrate 12 reflects differently from the inner layer 26a beneath the release layer 24 that remains with the substrate than from the substrate portion 34 surrounding the inner layer where the inner layer was removed with the light transmitting sheet 16. The inner layer 26a that remains on the substrate is visible as a contrasting positive image of the pattern or indicia.

An example of this is further illustrated in FIG. 3, wherein the film 10 is shown being removed from the substrate 12. The release layer is applied to the light transmitting sheet 16 in the form of the letter “V” which appears as a positive image on the substrate and as a negative image on the light transmitting sheet.

The light transmitting sheet 16 may be transparent or translucent and is preferably formed from polymers such as polyester, olefin, vinyl, styrene, acrylic, polyvinylchloride or polyimide.

Polyethyleneterepthalate is one example of a particular polymer that is advantageous for use as the light transmitting sheet. Alternately, the sheet may be formed of glassine or translucent paper to provide a translucent appearance. The sheet is preferably flexible and conformable so that it may be readily applied to a curved or irregular surface. The sheet may range in thickness between about 0.00025 inches (¼ mil) to about 0.02 inches for many practical applications.

The outer layer 22 is a metal layer and may be, for example, formed from aluminum, silver, gold, indium, tin or zinc that is applied directly to the sheet 16 by metalizing techniques such as vacuum deposition, vapor deposition and sputter processes. This allows the light transmissibility of the outer metal layer 22 to be in the range between about 85% to about 12%.

As shown in FIG. 1A, the outer layer 22 may also have a light transmitting primer layer 23 applied to it. The primer layer 23 functions to enhance the printability of the security film and may comprise polyester or a PVC resin for example. The primer layer 23 is preferably coated onto the outer layer 22 by techniques such as flood coating, offset or gravure printing and Meyer rod coating.

The inner layer 26, when a metal layer, may be formed from the same metals as the outer layer and deposited on the sheet and the release layer using the same techniques. Its light transmissibility ranges between about 10% to about 0%. The thickness of this inner metal layer ranges between about 30 to about 250 angstroms for practical applications. The inner metal layer 26 may also be a different metal from the outer metal layer 22, as long as both metals have similar optical properties such as the color of the light reflected.

The inner layer 26 as a non-metal layer may be formed from resins such as polyester, polyvinyl, acrylics, urethane, waxes, cellulosic resins or polyimides. The resins can have various colors and take on the appearance of metal. The colors may be imparted by dyes, tints or pigments. The thickness of the non-metal layer may range between 0.1 mils and 0.5 mils. The light transmissibility may range between about 10% to about 0%.

The release layer 24 is preferably applied to the sheet 16 in liquid or gel form allowing it to be conveniently printed on the sheet 16 in the desired pattern or indicia by known printing techniques such as offset printing and gravure. In one embodiment, the release layer forms a solid transparent layer that bonds weakly to the sheet 16 so that the sheet separates from the inner layer where the release layer is present. The release layer is preferably a urethane resin, but may also comprise cellulosic resins such as nitrocellulose, as well as polyvinyl alcohols, silicones, fluorinated compounds, electrically conductive compounds and waxes. It is advantageous that the release layer be as thin as possible yet still remain effective at providing a separation point between the layers. Release layer thicknesses between about 0.01 mils and about 0.5 mils are considered practical.

The adhesive layer 14 is preferably a pressure sensitive adhesive that is coated or laminated onto the inner layer and protected with a release paper. The release paper is removed before use, exposing the adhesive, which effects a bond between the film 10 and a substrate when pressure is applied to the film against the substrate. Other types of adhesive are also useable, including heat activated adhesives and glues.

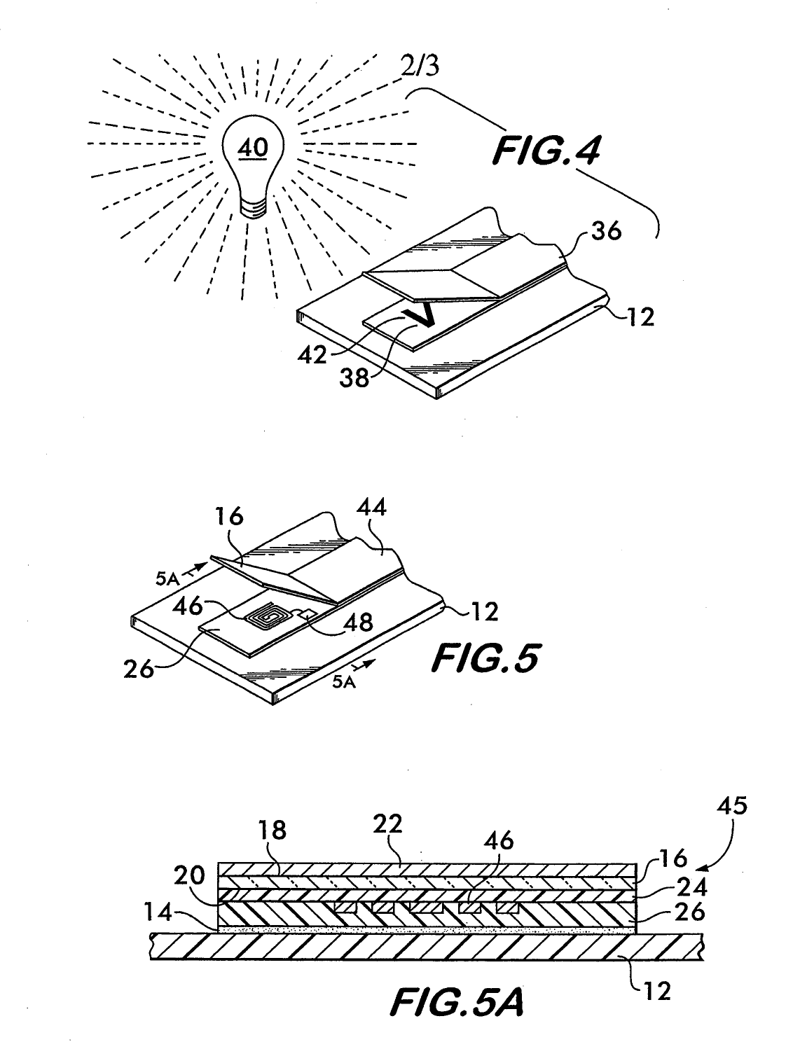

As shown in FIGS. 4-6, information may be encoded within the layers in many ways. FIG. 4 shows a film 36 having hidden indicia 38, for example, a trademark, that become visible when the layers are disrupted only when viewed under light outside of the visible spectrum, such as ultraviolet or infrared light 40. This is achieved by incorporating dyes or pigments 42 into the release layer that reflect or fluoresce under ultraviolet light. Such a film would be useful to deter counterfeiting.

FIG. 5 shows a film 44 wherein the pattern defined by the release layer is overprinted with an electrically conductive pattern forming an antenna 46 for a radio frequency identification tag or RFid. The antenna 46, formed in between the release layer 24 and a non-metal inner layer 26 remains with the substrate when the sheet 16 is removed. The antenna is connectable to an integrated circuit 48 to form the RFid tag which responds to an interrogating radiofrequency signal to identify and track the item to which the film 44 is attached. This embodiment would be useful in deterring theft, as the RFid, when exposed by removal of the sheet 16, will respond and trigger anti-theft alarms as are used in theft deterrent systems. FIG. 5A shows a cross-sectional view of the film embodiment 45 wherein the antenna 46 is printed on a non-metal inner layer 26, and a non-conductive release layer 24 covers the antenna 46 and the inner layer 26. The release layer 24 interfaces with the surface 20 of the light transmitting sheet 16, the opposite surface 18 of that sheet having a metal outer layer 22. Other types of electronic circuits could be substituted for the RF antenna, such as integrated circuits or larger scale conductive networks.

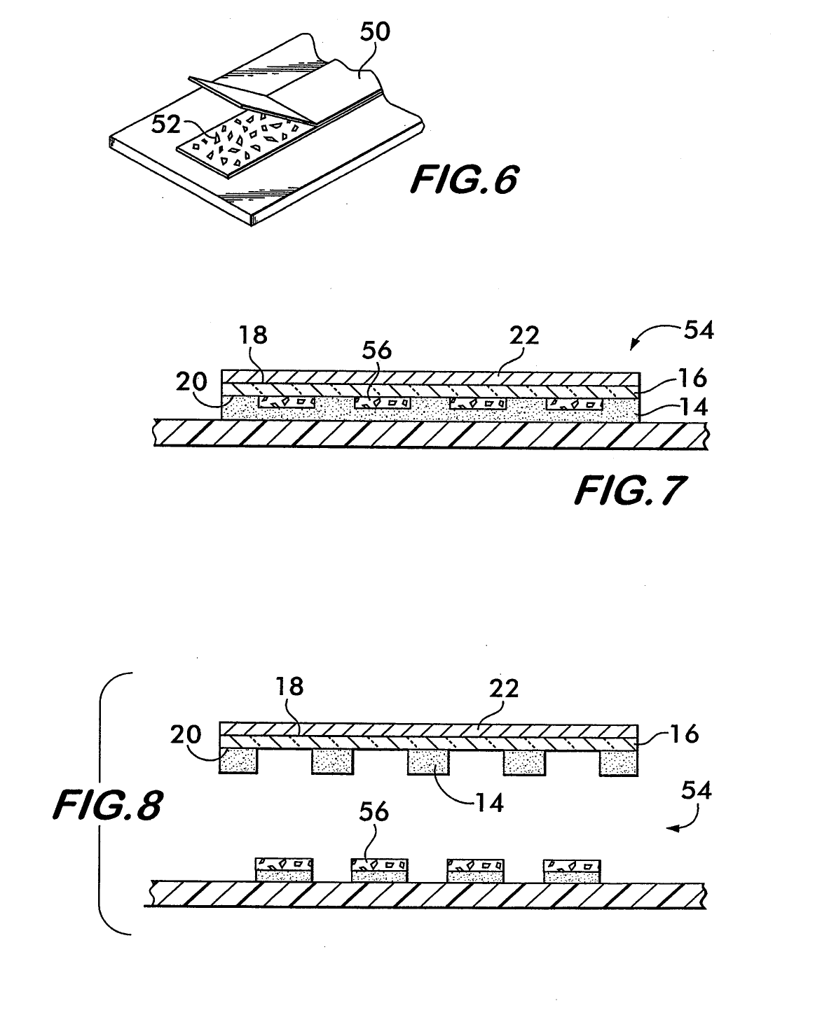

Film 50, shown in FIG. 6, has colored tagents 52 embedded within the release layer. The colored tagents become visible upon disruption of the layers. Instead of tagents, a hologram could also be used as a message indicating that the film has been tampered with.

An example film embodiment according to the invention comprises a light transmitting sheet formed of polyethyleneterepthalate having a thickness of 2 mils and a light transmissibility approaching 100%. An outer metal layer of aluminum having a light transmissibility of 85% is vacuum deposited on the outwardly facing surface of the sheet. A transparent release layer formed of urethane resin having a thickness of 0.05 mils is printed on the inwardly facing surface of the sheet in the form of indicia, such as the word “VOID”. An inner metal layer, also of aluminum, is vacuum deposited over the release layer and the remainder of the inwardly facing surface of the sheet to a thickness of 173 angstroms and a light transmissibility of less than 1%. A pressure sensitive adhesive is applied over the inner metal layer, the adhesive being protected by a release paper that is easily removable when the film is to be applied to a substrate.

In the example, it is also feasible to substitute a layer of polyester resin for the inner metal layer. The resin layer is about 0.25 mils thick and is tinted so as to have the same or a similar color as the outer layer 22, and a light transmissibility of less than 1%.

FIGS. 7 and 8 illustrate another embodiment 54 of a security film according to the invention. Film 54 comprises a light transmitting sheet 16 having oppositely disposed surfaces 18 and 20. An outer metal layer 22, as described above, is attached to the outwardly facing surface 18. A release layer 56 is positioned on the inwardly facing surface 20, and unlike the aforementioned embodiments, the release layer 56 is not transparent but tinted. Again, the release layer is applied as a pattern or in the form of indicia. An adhesive layer 14 overlies the inwardly facing surface 20 and covers the release layer 56 and the surface 20 where the release layer is absent. The outer layer 22 is a metal layer that has similar optical properties to the release layer. The optical properties, for example, the light reflectance and color of the outer layer, allows it to render the release layer 56 invisible when the intact film 54 is viewed. When the film is disrupted, for example, by removal of the light transmitting sheet 16 from a substrate 12 as shown in FIG. 8, the pattern or indicia become visible as described above for the other developments. The aforementioned description of the film embodiment 10 is largely applicable to the various components of the embodiment 54 and need not be repeated here. Again, the light transmissibility of the outer metal layer 22 is greater than the light transmissibility of the tinted release layer 56 to effect the invisibility of the pattern or indicia formed by the release layer.

Security film according to the invention provides a means to detect tampering and counterfeiting while avoiding the complications associated with multi-layer films of the prior art, especially with respect to the optical properties of the various layers.

What is claimed is:

1. A security film attachable to a substrate and adapted to display evidence of removal therefrom, said security film comprising:
a light transmitting sheet having a first and a second surface oppositely disposed;
a first metal layer attached to said first surface;
a transparent release layer attached to but a portion of said second surface; and
a second metal layer overlying said second surface, said second metal layer including a first portion attached to said release layer and a second portion attached to at least a portion of said second surface not covered by said release layer, said second metal layer being attachable to said substrate, said first metal layer having a higher light transmissibility than said second metal layer, said release layer having a greater adherence to said second metal layer than to said light transmitting sheet such that upon removal of said light transmitting sheet from said substrate, said first portion of said second metal layer remains attached to said substrate, and said second portion of said second metal layer remains attached to said light transmitting sheet.

2. A security film according to claim 1, further comprising an adhesive layer positioned over said second metal layer for attaching said security film to said substrate.

3. A security film according to claim 1, wherein said first metal layer has a light transmissibility between about 85% to about 12%.

4. A security film according to claim 3, wherein said second metal layer has a light transmissibility between about 10% to about 0%.

5. A security film according to claim 1, further comprising a light transmitting primer coated on said first metal layer.

6. A security film according to claim 1, wherein said release layer has the form of a trademark.

7. A security film attachable to a substrate and adapted to display evidence of removal therefrom, said security film comprising:
a light transmitting sheet having a first and a second surface oppositely disposed;
a first metal layer attached to said first surface;
a release layer attached to but a portion of said second surface; and
a second layer overlying said second surface, said second layer including a first portion attached to said release layer and a second portion attached to at least a portion of said second surface not covered by said release layer, said second layer being attachable to said substrate, said first layer having a higher light transmissibility than said second layer, said release layer having a greater adherence to said second layer than to said light transmitting sheet such that upon removal of said light transmitting sheet from said substrate, said first portion of said second layer remains attached to said substrate, and said second portion of said second layer remains attached to said light transmitting sheet.

8. A security film according to claim 7, further comprising a light transmitting primer coated on said first metal layer.

9. A security film according to claim 7, wherein said second layer comprises a metal layer.

10. A security film according to claim 7, wherein said second layer comprises a non-metal layer.

11. A security film according to claim 10, wherein said second layer comprises a pigmented layer.

12. A security film according to claim 10, wherein said first metal layer has a light transmissibility between about 85% to about 12% and said second layer has a light transmissibility between about 10% to about 0%.

13. A security film according to claim 7, wherein said release layer comprises a dye which is visible only under light outside of the visible spectrum.

14. A security film according to claim 7, wherein said release layer comprises colored tagents.

15. A security film attachable to a substrate and adapted to display evidence of removal therefrom, said security film comprising:
a light transmitting sheet having a first and a second surface oppositely disposed;
a metal layer attached to said first surface;
a release layer attached to said second surface;
a non-metal layer attached to said release layer, said non-metal layer being attachable to said substrate;
a radio frequency identification antenna being positioned between said release layer and said non-metal layer; and
wherein said release layer having a greater adherence to said non-metal layer than to said light transmitting sheet such that upon removal of said light transmitting sheet from said substrate, said radio frequency identification antenna is exposed and said non-metal layer remains attached to said light transmitting sheet.

16. A security film according to claim 15, further comprising an integrated circuit positioned between said release layer and said non-metal layer and in electrical communication with said radio frequency identification antenna.

17. A security film attachable to a substrate and adapted to display evidence of removal therefrom, said security film comprising:
a light transmitting sheet having a first and a second surface oppositely disposed;
a first metal layer attached to said first surface;
a release layer attached to but a portion of said second surface, said first metal layer having a higher light transmissibility than said release layer such that, when viewed through said first metal layer, said release layer is not visible; and
a second layer overlying said second surface, said second layer including a first portion attached to said release layer and a second portion attached to at least a portion of said second surface not covered by said release layer, said second layer being attachable to said substrate, said release layer having a greater adherence to said second layer than to said light transmitting sheet such that upon removal of said light transmitting sheet from said substrate, said release layer remains attached to said substrate.

18. A security film according to claim 17, wherein said second layer comprises an adhesive layer.

19. A security film according to claim 17, wherein said release layer is tinted.

20. A method of making a security film attachable to a substrate and adapted to display evidence of removal of said security film from said substrate, said method comprising:
providing a light transmitting sheet having a first and a second surface oppositely disposed;
metalizing said first surface with a metal layer having a first light transmissibility;
coating but a portion of said second surface with a release layer; and
applying to said second surface and said release layer a second layer having a second light transmissibility, said first light transmissibility being higher than said second light transmissibility.

21. A method according to claim 20, further including coating said second layer with an adhesive layer for attaching said security film to said substrate.

22. A method according to claim 20, further including coating said first metal layer with a light transmitting primer.

23. A method of making a security film attachable to a substrate and adapted to display evidence of removal of said security film from said substrate, said method comprising:
providing a light transmitting sheet having a first and a second surface oppositely disposed;
metalizing said first surface with a metal layer;
coating but a portion of said second surface with a release layer, said first metal layer having a higher light transmissibility than said release layer such that, when viewed through said first metal layer, said release layer is not visible; and
applying to said second surface and said release layer a second layer, said second layer being attachable to said substrate, said release layer having a greater adherence to said second layer than to said light transmitting sheet such that upon removal of said light transmitting sheet from said substrate, said release layer remains attached to said substrate.
